(19) United States
(12) Patent Application Publication
(10) Pub. No.: US 2017/0310857 A1
(43) Pub. Date: Oct. 26, 2017

(54) CAMERA SYSTEM AND APPARATUS THEREOF

(71) Applicant: eYs3D Microelectronics, Co., TAIPEI CITY (TW)

(72) Inventor: Kuan-Cheng Chung, New Taipei City (TW)

(21) Appl. No.: 15/426,065

(22) Filed: Feb. 7, 2017

Related U.S. Application Data
(60) Provisional application No. 62/326,016, filed on Apr. 22, 2016.

(30) Foreign Application Priority Data
Jul. 7, 2016 (TW) 105210309
Oct. 8, 2016 (CN) 201621102784.X

(51) Int. Cl. H04N 5/225; H01R 12/72; H01R 24/64; H04N 5/232; H01R 107/00

(52) U.S. Cl. CPC H04N 5/2252; H04N 5/23238; H04N 5/2257; H04N 5/2254; H01R 12/724; H04N 5/2253; H01R 24/64; H01R 2107/00

(57) ABSTRACT

A camera apparatus includes a shell and a first printed circuit board. The shell encloses to form an accommodation space, and a maximum size of the shell corresponding to a non-predetermined axis is less than a predetermined value. The first printed circuit board is installed within the accommodation space, and a first lens group and a second lens group are installed on opposite sides of the first printed circuit board respectively for capturing image data corresponding to a shooting area and outputting the image data to a sound capturing apparatus. The image data includes a plurality of image segments, and each of the plurality of image segments has a time tag. When the sound capturing apparatus receives the image data, the sound capturing apparatus optionally combines the image data with audio data corresponding to the shooting area according to time tags of the plurality of image segments.

### CROSS REFERENCE TO RELATED APPLICATIONS

This application claims the benefit of U.S. Provisional Application No. 62/326,016, filed on Apr. 22, 2016 and entitled “Panorama Camera attachable to portable device,” the contents of which are incorporated herein by reference.

### BACKGROUND OF THE INVENTION

### 1. Field of the Invention

The present invention relates to a camera system and an apparatus thereof, and particularly to a camera system and an apparatus that can capture image data and audio data, respectively.

### 2. Description of the Prior Art

A ball panorama camera (BPC) provided by the prior art includes a shell, wherein a plurality of lens groups arranged in a spherical shape are installed within the shell. The plurality of lens groups can simultaneously shoot a scene surrounding the BPC toward different view angles respectively to obtain images surrounding the BPC for synthesizing a panorama image.

General speaking, because the BPC needs to work with a portable apparatus when the BPC shoots the scene surrounding the BPC, a size of the BPC will be limited for carrying on the BPC conveniently. Therefore, if a designer wants to simultaneously install components and circuit boards electrically connected to the plurality of lens groups in a limited accommodation space within the shell of the BPC, configurations within the shell for the components and circuit boards will become a significant issue for the designer and a manufacturer producing the BPC.

### SUMMARY OF THE INVENTION

A purpose of the present invention is used for solving the above mentioned significant issue by not installing any sound capturing component in an accommodation space within a camera apparatus and proper configurations between lens groups and circuit boards installed in the accommodation space.

An embodiment of the present invention provides a camera apparatus. The camera apparatus includes a shell and a first printed circuit board. The shell encloses to form an accommodation space, wherein a maximum size of the shell corresponding to a non-predetermined axis is less than a predetermined value. The first printed circuit board is installed within the accommodation space, wherein a first lens group and a second lens group are installed on opposite sides of the first printed circuit board, respectively. The first lens group and the second lens group are used for capturing and outputting image data corresponding to a shooting area, the image data include a plurality of image segments, and each image segment of the plurality of image segments has a time tag. The image data are combined with audio data corresponding to the shooting area according to time tags of the plurality of image segments, and the audio data are generated from an external apparatus.

Another embodiment of the present invention provides a camera system. The camera system includes a camera apparatus and a sound capturing apparatus. The camera apparatus includes a shell and a first printed circuit board. The shell encloses to form an accommodation space, wherein a maximum size of the shell corresponding to a non-predetermined axis is less than a predetermined value. The first printed circuit board is installed within the accommodation space, wherein a first lens group and a second lens group are installed on opposite sides of the first printed circuit board, respectively. The first lens group and the second lens group are used for capturing image data corresponding to a shooting area, the image data include a plurality of image segments, and each image segment of the plurality of image segments has a time tag. The sound capturing apparatus electrically connected to the camera apparatus includes a sound capturing circuit and a sound processor. When the first lens group and the second lens group capture the image data, the sound capturing circuit optionally captures audio data corresponding to the shooting area. When the sound processor receives the audio data captured by the sound capturing circuit, the sound processor combines the image data with the audio data according to time tags of the plurality of image segments.

The present invention provides a camera system and a camera apparatus. The camera system and the camera apparatus can make an accommodation space of the camera apparatus be increased, or shrink a size of a shell of the camera apparatus by not installing any sound capturing component in the accommodation space of the camera apparatus and proper configurations between lens groups and circuit boards installed in the accommodation space. When a user chooses to capture environmental sound and images, image data captured by the camera apparatus can be combined with audio data captured by a sound capturing apparatus by time tags corresponding to the image data captured by the camera apparatus to form AV data. Thus, the present invention can utilize the accommodation space within the camera apparatus effectively, flexibly adjust the size of the camera apparatus, determine whether to mix the audio data captured by the sound capturing apparatus with the image data captured by the camera apparatus, and make overall use of the camera apparatus more flexible and convenient.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a camera apparatus and an electronic apparatus according to an embodiment of the present invention.

FIG. 2 is a diagram illustrating a cross-section of the camera apparatus.

FIG. 3 is a diagram illustrating function blocks of the camera apparatus on a first printed circuit board and function blocks of the electronic apparatus.

FIG. 4A and FIG. 4B are diagrams illustrating a three-dimensional appearance of a camera apparatus according to another embodiment of the present invention.

FIG. 5 is a diagram illustrating a cross-section of the camera apparatus.

FIG. 6 is an explosion diagram of the camera apparatus.

FIG. 7A to FIG. 7F are diagrams illustrating a six-side view of the camera apparatus.

### DETAILED DESCRIPTION

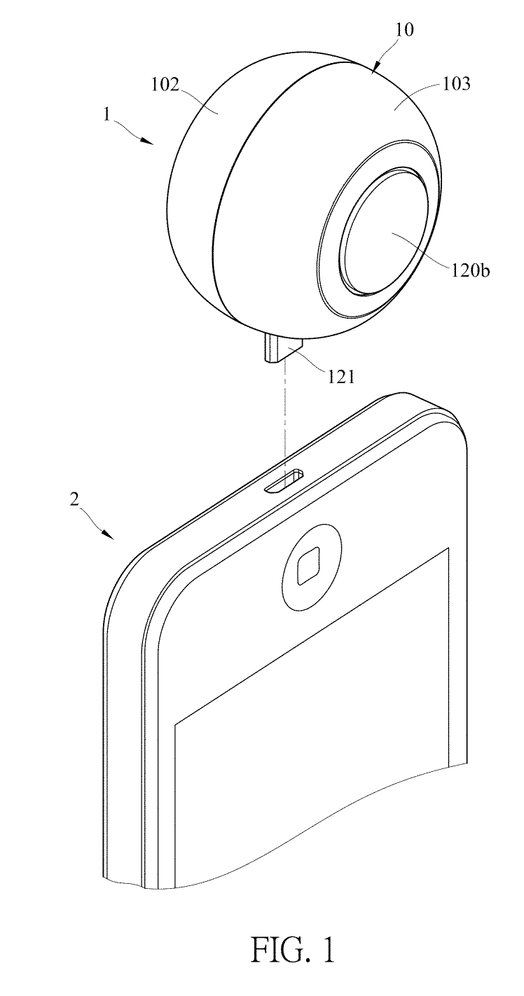

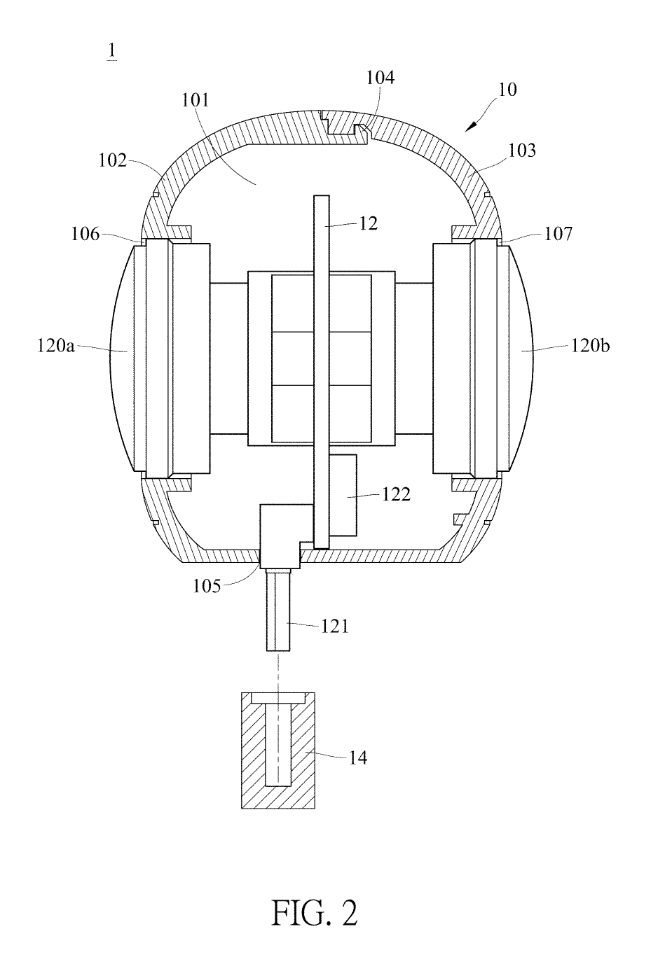

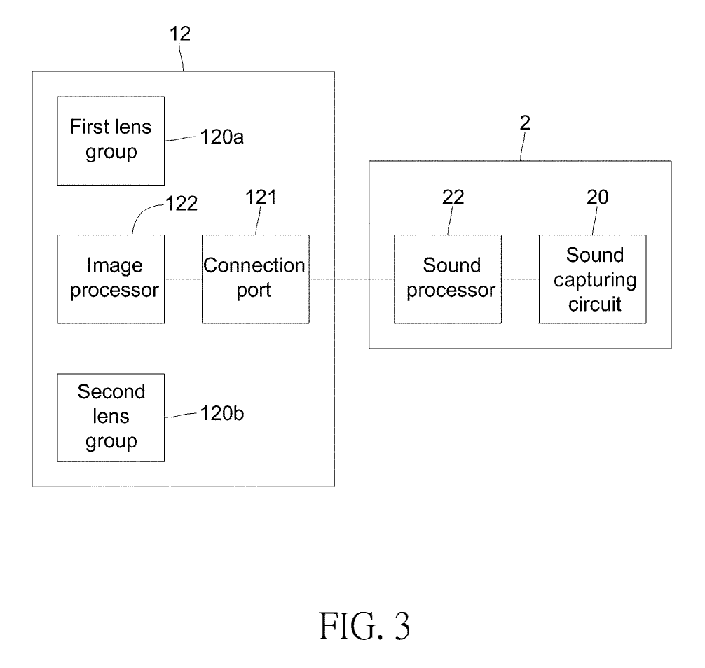

Please refer to FIGS. 1-3. FIG. 1 is a diagram illustrating a camera apparatus 1 and an electronic apparatus 2 according to an embodiment of the present invention, FIG. 2 is a diagram illustrating a cross-section of the camera apparatus 1, and FIG. 3 is a diagram illustrating function blocks of the camera apparatus 1 on a first printed circuit board 12 and function blocks of the electronic apparatus 2. As shown in FIG. 2, the camera apparatus 1 includes a shell 10, an inside of the shell 10 defines an accommodation space 101, and the shell 10 encloses the first printed circuit board 12. That is to say, the first printed circuit board 12 is installed within the accommodation space 101, wherein the first printed circuit board 12 can be a flexible substrate, a glass substrate, a quartz substrate, a silicon substrate, or other proper substrates. As shown in FIG. 2, in one embodiment of the present invention, a first lens group 120a, a second lens group 120b, a connection port 121, and an image processor 122 are installed on the first printed circuit board 12. But, the present invention is not limited to a number of lens groups and a layout corresponding to the first lens group 120a, the second lens group 120b, the connection port 121, and the image processor 122 on the first printed circuit board 12 shown in FIG. 2.

As shown in FIG. 2, the shell 10 can be composed of combinational shell components, wherein the shell 10 includes a first component 102 and a second component 103, and the first component 102 can be combined with the second component 103 by a buckle component 104. Bottoms of the first component 102 and the second component 103 have nicks, respectively, wherein the nicks of the first component 102 and the second component 103 are used for forming a hole 105 when the first component 102 is combined with the second component 103, and make the connection port 121 protrude the shell 10 from the inside of the shell 10 to be electrically connected to the electronic apparatus 2. The connection port 121 can be a universal serial bus (USB) transmission interface, a micro USB transmission interface, a USB type C transmission interface, a lighting transmission interface, or other transmission interfaces which can be applied to the electronic apparatus 2. But, the present invention is not limited to sizes and shapes of the first component 102 and the second component 103 and a configuration of the buckle component 104, and also not limited to the hole 105 being formed by a combination of the first component 102 and the second component 103. That is to say, in another embodiment of the present invention, the hole 105 can also be designed to be directly formed in the first component 102 or the second component 103 according to a position of the connection port 121.

In practice, for the connection port 121 being conveniently electrically connected to the electronic apparatus 2, the connection port 121 is installed on the bottom of the first printed circuit board 12. Further, for protecting the connection port 121, the connection port 121 can be automatically or passively stowed into the accommodation space 101 within the shell 10, or a protective case 14 can be additionally utilized to enclose a part of the connection port 121 protruding the shell 10, but the present invention is not limited to the above mentioned protection for the connection port 121. In another embodiment of the present invention, the connection port 121 can be electrically connected to the first printed circuit board 12 through a connection line (not shown in FIG. 2), and the connection line can be controlled by a winding machine (not shown in FIG. 2) within the accommodation space 101. In addition, the connection line and the connection port 121 can be stowed into the accommodation space 101 within the shell 10 by the winding machine, and can also be automatically or passively pulled outside the shell 10 by penetrating the hole 105 to be electrically connected to the electronic apparatus 2. Further, when a position of the hole 105 is regarded as a bottom of the shell 10, the winding machine can be installed between the first printed circuit board 12 and the bottom of the shell 10, or between the first printed circuit board 12 and a top of the shell 10, but the present invention is not limited to the above mentioned configurations of the winding machine.

For shooting environmental images outside the shell 10, the first lens group 120a and the second lens group 120b are installed on opposite sides of the first printed circuit board 12, and the first component 102 and the second component 103 have a penetration slot 106 and a penetration slot 107 respectively, so the first lens group 120a and the second lens group 120b can capture the images outward the shell 10 through the penetration slot 106 and the penetration slot 107, respectively. Further, the first lens group 120a and the second lens group 120b can be fisheye lenses or other types of lenses, but the present invention is not limited to the first lens group 120a and the second lens group 120b being fisheye lenses.

After the first lens group 120a and the second lens group 120b capture the images outside the shell 10, the image processor 122 can combine image data captured by the first lens group 120a and the second lens group 120b to synthesize panorama image data, and tags capturing time to the image data captured by the first lens group 120a and the second lens group 120b. Specifically, the image processor 122 divides the panorama image data into a plurality of image segments, and tags a corresponding time tag (e.g. a time stamp) to each image segment of the plurality of image segments, wherein the corresponding time tag is used for indicating decoding time or decoding sequence corresponding to regeneration of the each image segment.

In another embodiment of the present invention, the image processor 122 can also process the image data captured by the first lens group 120a and the second lens group 120b, respectively, that is, the image processor 122 tags time tags to the image data captured by the first lens group 120a and the second lens group 120b, respectively. In other words, the image processor 122 does not necessarily tag time tags to the panorama image data after the image processor 122 combines the image data captured by the first lens group 120a and the second lens group 120b to synthesize the panorama image data. In another embodiment of the present invention, the image processor 122 can be installed in another apparatus outside the camera apparatus 1, or the first lens group 120a has an image processor thereof and the second lens group 120b also has an image processor thereof to process and tag the image data captured by the first lens group 120a and the second lens group 120b. Therefore, the image data captured by the first lens group 120a and the second lens group 120b can be time synchronization.

In practice, in addition to tagging the capturing time to the image data captured by the first lens group 120a and the second lens group 120b, the image processor 122 can further adjust setting values of the first lens group 120a and the second lens group 120b when the first lens group 120a and the second lens group 120b capture the image data. For example, the image processor 122 can adjust focal lengths, apertures, or other proper setting parameters of the first lens group 120a and the second lens group 120b to be the substantially same. In addition, the image processor 122 can further adjust image data parameters (e.g. luminance, contrast, and color balance of the image data) corresponding to the image data respectively to be the substantially same after the first lens group 120a and the second lens group 120b capture the image data. But, the present invention is not limited to the image processor 122 adjusting luminance, contrast, and color balance of the image data captured by the first lens group 120a and the second lens group 120b respectively to be the substantially same. Accordingly, the image data captured by the first lens group 120a and the second lens group 120b can be color synchronization. That is to say, when the image processor 122 combines the image data captured by the first lens group 120a and the second lens group 120b to form the panorama image data, the panorama image data do not have color, luminance, or other image incompatibility issues, so a user can watch image generated by the camera apparatus 1 more comfortably.

When the image generated by the camera apparatus 1 are outputted, the image generated by the camera apparatus 1 will be optionally combined with audio data generated by an external apparatus. That is to say, the audio data are generated from the external apparatus outside the camera apparatus 1, rather than being generated by the camera apparatus 1. Taking FIG. 1 as an example, the camera apparatus 1 is electrically connected to the electronic apparatus 2 through the connection port 121, and the electronic apparatus 2 is a sound capturing apparatus for capturing environmental sound near the electronic apparatus 2. For example, the electronic apparatus 2 can be a mobile phone, a tablet computer, a laptop computer, a desktop computer, or other apparatus with sound capturing function. The electronic apparatus 2 has a sound capturing circuit 20 and a sound processor 22. The sound capturing circuit 20 captures audio data corresponding to the shooting area together when the camera apparatus 1 captures images corresponding to the shooting area. When the sound processor 22 receives image data corresponding to the shooting area captured by the camera apparatus 1, the sound processor 22 optionally combines the audio data corresponding to the shooting area with the image data corresponding to the shooting area captured by the camera apparatus 1 according to time tags of the image data corresponding to the shooting area captured by the camera apparatus 1.

Taking the electronic apparatus 2 as an example of a mobile phone, when the camera apparatus 1 is electrically connected to the electronic apparatus 2, the electronic apparatus 2 can automatically or passively enable an application program corresponding to the camera apparatus 1. The application program can display and capture the image generated by the camera apparatus 1, and notice the user whether to capture the environmental sound near the electronic apparatus 2. When the user chooses to capture the environmental sound near the electronic apparatus 2, the application program notices the electronic apparatus 2 to turn on the sound capturing circuit 20, and the sound capturing circuit 20 captures the environmental sound near the electronic apparatus 2.

In one embodiment of the present invention, the audio data captured by the sound capturing circuit 20 includes a plurality of sound segments, and each sound segment of the plurality of sound segments has a corresponding synchronization tag. The corresponding synchronization tag can be a time stamp, and also be information indicating the each sound segment to correspond to a corresponding image segment. In other words, when the corresponding synchronization tag is a time stamp, the corresponding synchronization tag can indicate decoding time or decoding sequence corresponding to regeneration of the each sound segment, wherein the each sound segment can be simultaneously regenerated with the corresponding image segment. When the corresponding synchronization tag is the information indicating the each sound segment to correspond to the corresponding image segment, the each sound segment is simultaneously decoded to regenerate with regeneration of the corresponding image segment. In practice, the sound processor 22 can combine the each sound segment with the corresponding image segment to form an audio and video (AV) segment according to a time tag of the corresponding image segment and the corresponding synchronization tag of the each sound segment, wherein a stream of AV segments can form AV data. In other words, when the user chooses to capture the environmental sound near the electronic apparatus 2, the sound processor 22 combines the image data generated by the camera apparatus 1 with the audio data captured by the sound capturing circuit 20 to form the AV data, wherein the AV data can includes time stamps, but the present invention is not limited to the AV data including time stamps.

In practice, for correctly processing the AV data, a time length of the each sound segment is equal to a time length of the corresponding image segment, so the sound processor 22 can combine the time tag of the image segment with the corresponding synchronization tag of the each sound segment more effectively. But, the present invention is not limited to the time length of the each sound segment being equal to the time length of the corresponding image segment. That is to say, any division way which can make the each sound segment and the corresponding image segment be simultaneously regenerated falls within the scope of the present invention.

Therefore, by not installing any sound capturing component in the accommodation space 101, the camera apparatus 1 can make the sound capturing circuit 20 of the electronic apparatus 2 or other sound capturing apparatuses outside the shell 10 capture sound corresponding to the shooting area to increase a region of the accommodation space 101 for accommodating other components. Thus, the present invention can further increase the number of lens groups, a number of winding machines for controlling the connection line, or other proper elements, or further shrink a size of the shell 10 to make the camera apparatus 1 be carried more conveniently. Therefore, use of the camera apparatus 1 can also be more diversified and convenient. In addition, the camera apparatus 1 can only include a single printed circuit board (i.e. the first printed circuit board 12) to implement a complete image recording function with very small size. For example, a maximum size of the shell 10 corresponding to a non-predetermined axis is equal to or less than 5 cm. In another embodiment of the present invention, after neglecting any component protruding the shell 10, the maximum size of the shell 10 may be equal to or less than 3.6 cm.

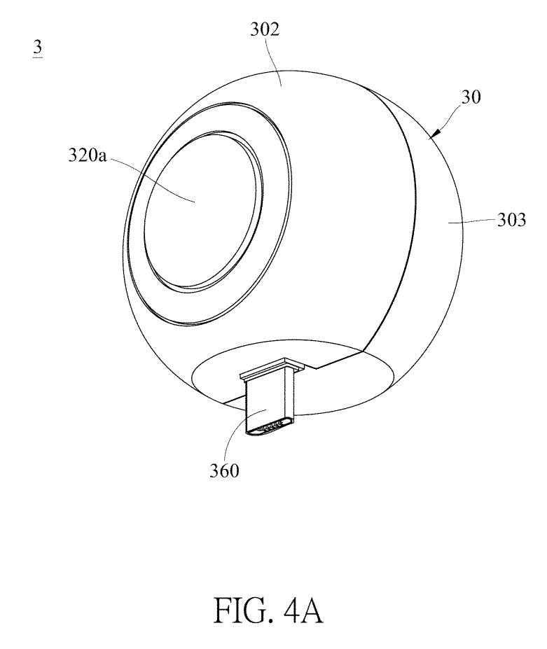

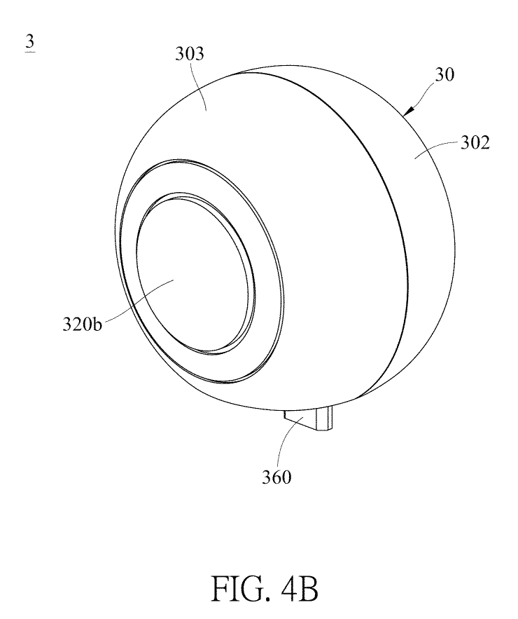

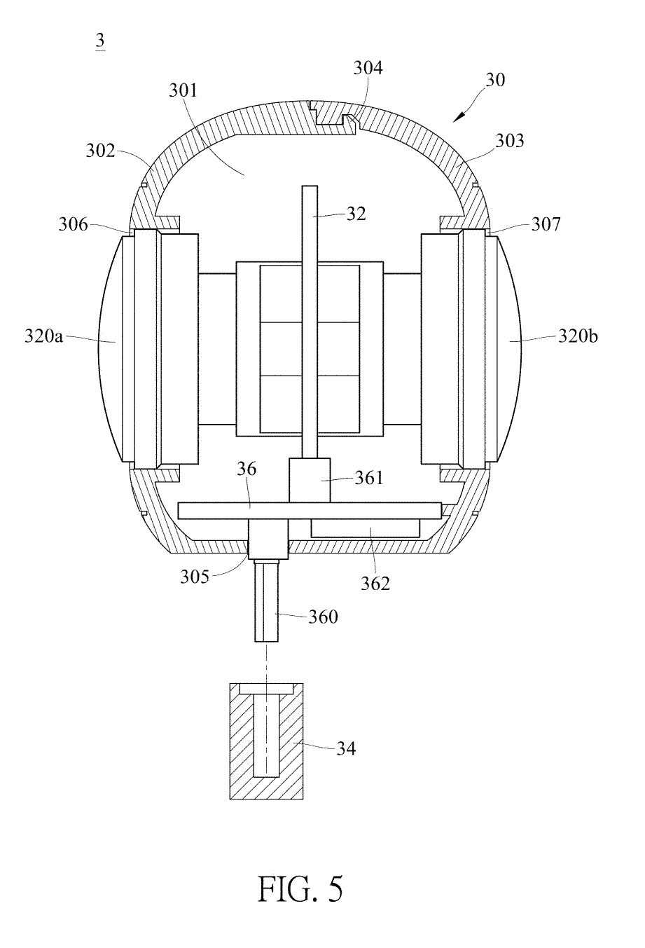

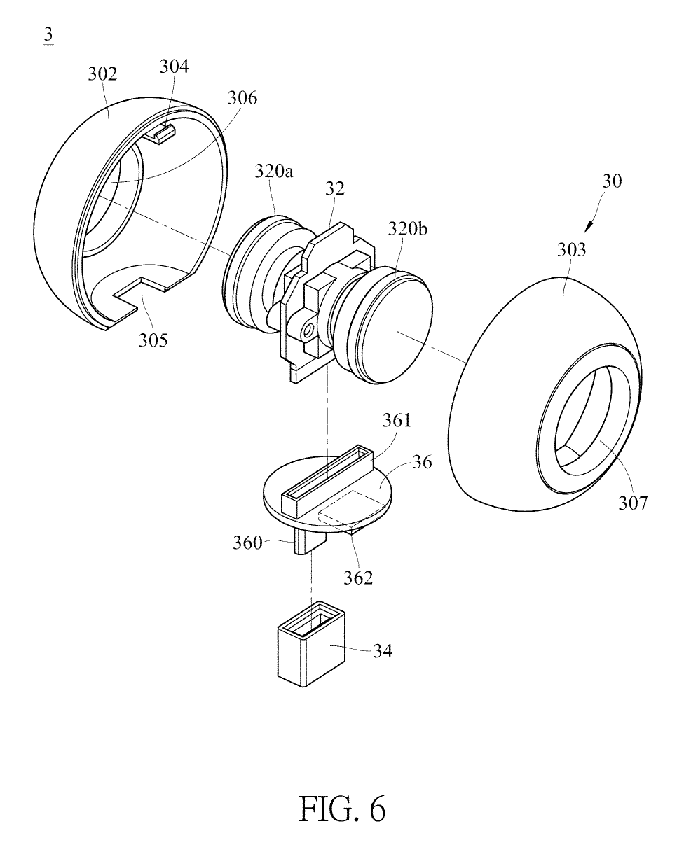

In addition, please refer to FIGS. 1, 3, 4A-6. FIG. 4A and FIG. 4B are diagrams illustrating a three-dimensional (3D) appearance of a camera apparatus 3 according to another embodiment of the present invention, FIG. 5 is a diagram illustrating a cross-section of the camera apparatus 3, FIG. 6 is an explosion diagram of the camera apparatus 3. As shown in FIG. 4A, the camera apparatus 3 includes a shell 30, the shell 30 can be composed of combinational shell components, and has a first component 302 and a second component 303, wherein the first component 302, the second component 303, and a buckle component 304 (shown in FIG. 5) can combine each other to define an accommodation space 301. In one embodiment of the present invention, bottoms of the first component 302 and the second component 303 have nicks respectively, the nicks of the first component 302 and the second component 303 are used for forming a hole 305 when the first component 302 is combined with the second component 303, but the present invention is not limited to the hole 305 being formed when the first component 302 is combined with the second component 303.

As shown in FIG. 5, a first printed circuit board 32 and a second printed circuit board 36 are installed within the accommodation space 301. Except the first printed circuit board 32 and the second printed circuit board 36 having different functional circuit components respectively, the first printed circuit board 32 and the second printed circuit board 36 form a 3D combinational circuit board, and the first printed circuit board 32 and the second printed circuit board 36 are not located on the same plane. In one embodiment of the present invention, at least one lens group (e.g. a first lens group 320a and a second lens group 320b) is installed on one of the first printed circuit board 32 and the second printed circuit board 36. That is to say, the present invention is not limited to the first lens group 320a and the second lens group 320b being installed on which one of the first printed circuit board 32 and the second printed circuit board 36. For conveniently describing the camera apparatus 3, the first lens group 320a and the second lens group 320b are installed on the first printed circuit board 32, and a connection port 360, an engagement component 361, and an image processor 362 are installed on the second printed circuit board 36.

As shown in FIG. 5, the connection port 360 can be pulled outside the shell 30 by penetrating the hole 305 to be electrically connected to an external electronic apparatus. The connection port 360 can be a USB transmission interface, a micro USB transmission interface, a USB type C transmission interface, a lighting transmission interface, or other transmission interfaces which can be applied to the electronic apparatus. In practice, for the connection port 360 being conveniently electrically connected to the electronic apparatus, the connection port 360 is installed on a bottom of the second printed circuit board 36. Further, for protecting the connection port 360, the connection port 360 can be automatically or passively stowed into the accommodation space 301 within the shell 30, or a protective case 34 can be additionally utilized to enclose a part of the connection port 360 protruding the shell 30, but the present invention is not limited to the above mentioned protection for the connection port 360. In another embodiment of the present invention, the connection port 360 can be electrically connected to the second printed circuit board 36 through a connection line (not shown in FIG. 5), and the connection line can be controlled by a winding machine (not shown in FIG. 5) within the accommodation space 301. In addition, the connection line and the connection port 360 can be stowed into the accommodation space 301 by the winding machine, and can also be automatically or passively pulled outside the shell 30 by penetrating the hole 305 to be electrically connected to the electronic apparatus. Further, when a position of the hole 305 is regarded as a bottom of the shell 30, the winding machine can be installed between the first printed circuit board 32 and the bottom of the shell 30, or between the first printed circuit board 32 and a top of the shell 30, but the present invention is not limited to the above mentioned configurations of the winding machine.

Although the present invention is not limited to shapes of the first printed circuit board 32 and the second printed circuit board 36, the first printed circuit board 32 can be electrically connected to and contact with the second printed circuit board 36 through the engagement component 361. As shown in FIG. 5, the first printed circuit board 32 is substantially perpendicular to the second printed circuit board 36. Further, under the first printed circuit board 32 not protruding the second printed circuit board 36, the first printed circuit board 32 and the second printed circuit board 36 can be combined to form a combinational circuit board with “T” shape, but the present invention is not limited to a relative size relationship between the first printed circuit board 32 and the second printed circuit board 36. That is to say, a size of the first printed circuit board 32 is not necessarily greater than a size of the second printed circuit board 36, and the first printed circuit board 32 is also not necessarily installed at a center of the second printed circuit board 36. Any configuration in which the first printed circuit board 32 and the second printed circuit board 36 can be installed in the accommodation space 301, and a maximum size of the shell 30 is within a predetermined range falls within the scope of the present invention, wherein the predetermined range will be described later.

In practice, the engagement component 361 can be a groove and peripheral area thereof not protruding the second printed circuit board 36, and should have at least one terminal for electrical connection, and one end of the first printed circuit board 32 should also have a corresponding terminal. Thus, when the end of the first printed circuit board 32 contacts with the engagement component 361 of the second printed circuit board 36, the first printed circuit board 32 can be coupled to the second printed circuit board 36. Further, for making a coupling relationship between the first printed circuit board 32 and the second printed circuit board 36 be more stable, corresponding terminals of the first printed circuit board 32 and the second printed circuit board 36 can be welded together to prevent from poor contact after the end of the first printed circuit board 32 contacts with the engagement component 361 of the second printed circuit board 36.

In addition, the engagement component 361 can also be a slot, a groove, or a through hole penetrating the second printed circuit board 36, and meanwhile the engagement component 361 also has at least one terminal for electrical connection to provide the first printed circuit board 32 to contact with and be electrically connected to the second printed circuit board 36. As described in the above mentioned embodiment, for making the coupling relationship between the first printed circuit board 32 and the second printed circuit board 36 be more stable, the corresponding terminals of the first printed circuit board 32 and the second printed circuit board 36 can be welded together to prevent from poor contact after the first printed circuit board 32 protrudes the engagement component 361. Further, under the first printed circuit board 32 protruding the second printed circuit board 36, the first printed circuit board 32 and the second printed circuit board 36 can be combined to form a combinational circuit board with “+” shape, but the present invention is not limited to a size of a part of the first printed circuit board 32 protruding the second printed circuit board 36.

Although FIG. 5 only shows the first printed circuit board 32 and the second printed circuit board 36, in practice, the accommodation space 301 within the shell 30 can also still accommodate another circuit board (e.g. a third circuit board) which can be combined with the first printed circuit board 32 and the second printed circuit board 36 to form a combinational circuit board with relative relationship from top to bottom. In other words, under the first printed circuit board 32 not protruding the second printed circuit board 36, the first printed circuit board 32, the second printed circuit board 36, and the third circuit board can combine to form a combinational circuit board with “±” or “I” shape. In another embodiment of the present invention, the first printed circuit board 32 can protrude the second printed circuit board 36, that is, the present invention is not limited to the above mentioned configurations of the first printed circuit board 32, the second printed circuit board 36, and the third circuit board. Except the above mentioned configurations of “T” shape, “+” shape, “±”, or “I” shape composed of at least one of the first printed circuit board 32, the second printed circuit board 36, and the third circuit board, the present invention can also utilize one circuit board or more circuit boards to bend to the above mentioned configurations of “T” shape, “+” shape, “±”, or “I” shape.

For shooting environmental images outside the shell 30, the first lens group 320a and the second lens group 320b are installed on opposite sides of the first printed circuit board 32, and the first component 302 and the second component 303 have a penetration slot 306 and a penetration slot 307 respectively, so the first lens group 320a and the second lens group 320b can capture the images outward the shell 30 through the penetration slot 306 and the penetration slot 307, respectively. Further, the first lens group 320a and the second lens group 320b can be fisheye lenses or other types of lenses, but the present invention is not limited to the first lens group 320a and the second lens group 320b being fisheye lenses.

After the first lens group 320a and the second lens group 320b capture the images outside the shell 30, the image processor 322 combines image data captured by the first lens group 320a and the second lens group 320b to synthesize panorama image data, and tags capturing time of the image data captured by the first lens group 320a and the second lens group 320b. Specifically, the image processor 322 divides the panorama image data into a plurality of image segments, and tags a corresponding time tag to each image segment of the plurality of image segments, wherein the corresponding time tag is used for indicating decoding time or decoding sequence corresponding to regeneration of the each image segment. But, the present invention is not limited to the image processor 322 tagging the corresponding time tag to the each image segment of the plurality of image segments. In another embodiment of the present invention, the image processor 322 can also process the image data captured by the first lens group 320a and the second lens group 320b, respectively, and tag the image data captured by the first lens group 320a and the second lens group 320b with time tags, respectively.

When image generated by the camera apparatus 3 are outputted, the image generated by the camera apparatus 3 will be optionally combined with audio data generated by an external apparatus. That is, any component for capturing audio data is not installed in the accommodation space 301 within the camera apparatus 3 and the audio data are generated from the external apparatus (e.g. the electronic apparatus 2 (shown in FIG. 1) or proper sound capturing apparatuses) outside the camera apparatus 3. Taking the electronic apparatus 2 in FIG. 1 as an example, the camera apparatus 3 utilizes the connection port 321 to be electrically connected to the electronic apparatus 2, and the electronic apparatus 2 is a sound capturing apparatus for capturing environmental sound near the electronic apparatus 2. For example, the electronic apparatus 2 can be a mobile phone, a tablet computer, a laptop computer, a desktop computer, or other apparatus with sound capturing function. The sound capturing circuit 20 captures audio data corresponding to the shooting area together when the camera apparatus 3 captures images corresponding to the shooting area. When the sound processor 22 receives the images corresponding to the shooting area captured by the camera apparatus 3, the sound processor 22 optionally combines the audio data corresponding to the shooting area with the images corresponding to the shooting area captured by the camera apparatus 3 according to time tags of the image data corresponding to the shooting area captured by the camera apparatus 3.

When the camera apparatus 3 is electrically connected to the electronic apparatus 2, the electronic apparatus 2 can automatically or passively enable an application program corresponding to the camera apparatus 3. The application program can display and capture the image generated by the camera apparatus 3, and notice the user whether to capture the environmental sound near the electronic apparatus 2. When the user chooses to capture the environmental sound near the electronic apparatus 2, the application program notices the electronic apparatus 2 to turn on the sound capturing circuit 20, and the sound capturing circuit 20 captures the environmental sound near the electronic apparatus 2.

The audio data captured by the sound capturing circuit 20 includes a plurality of sound segments, and each sound segment of the plurality of sound segments has a corresponding synchronization tag and a corresponding image segment corresponds to the each sound segment. The sound processor 22 can combine the each sound segment with the corresponding image segment to form an AV segment according to a time tag of the corresponding image segment and the corresponding synchronization tag of the each sound segment, wherein a stream of AV segments can form AV data. That is to say, when the user chooses to capture the environmental sound near the electronic apparatus 2, the sound processor 22 combines the image generated by the camera apparatus 3 with the audio data captured by the sound capturing circuit 20 to form the AV data, wherein the AV data can includes time stamps, but the present invention is not limited to the AV data including time stamps.

By a combination of the first printed circuit board 32 and the second printed circuit board 36, the present invention can make the camera apparatus 3 utilize a very small size to implement a complete image recording function. For example, when a size of the shell 30 is measured from the outside of the shell 30, the maximum size of the shell 30 corresponding to a non-predetermined axis should be equal to or less than 5 cm. In one embodiment of the present invention, after neglecting any component protruding the shell 30, the maximum size of the shell 30 should be equal to or less than 3.6 cm. In practice, a shape of the outside of the shell 30 can be substantially circular or oval. But, a shape of the accommodation space 301 within the shell 30 is not necessary the same as the shape of the outside of the shell 30. That is to say, the present invention is not limited to the shape of the accommodation space 301 within the shell 30 shown in FIG. 5.

On the other hand, when the size of the shell 30 is measured from the inside of the shell 30, taking the first lens group 320a and the second lens group 320b being installed on opposite sides of the first printed circuit board 32 as an example, under a vertical direction, a width of the first printed circuit board 32 is equal to or less than 2.7 cm (e.g. the width of the first printed circuit board 32 can be equal to 2.58 cm) from one end of the first printed circuit board 32 to the other end of the first printed circuit board 32; under a horizontal direction, a total width of a combination of the first printed circuit board 32, the first lens group 320a, and the second lens group 320b should also be less than 3.6 cm (e.g. the total width of the combination of the first printed circuit board 32, the first lens group 320a, and the second lens group 320b can be about 3.38 cm).

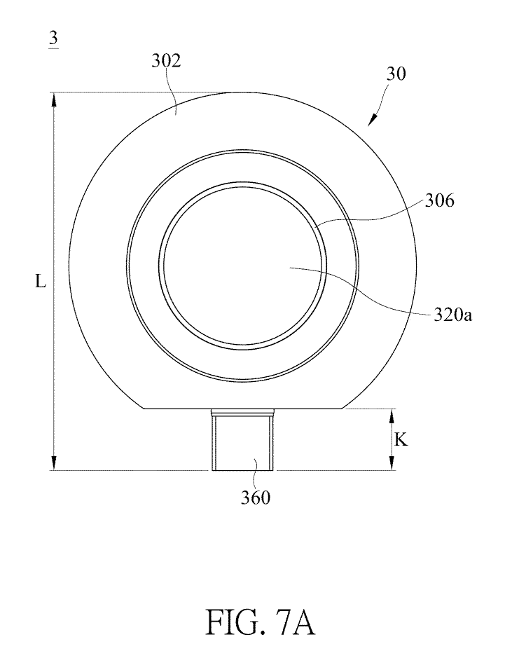

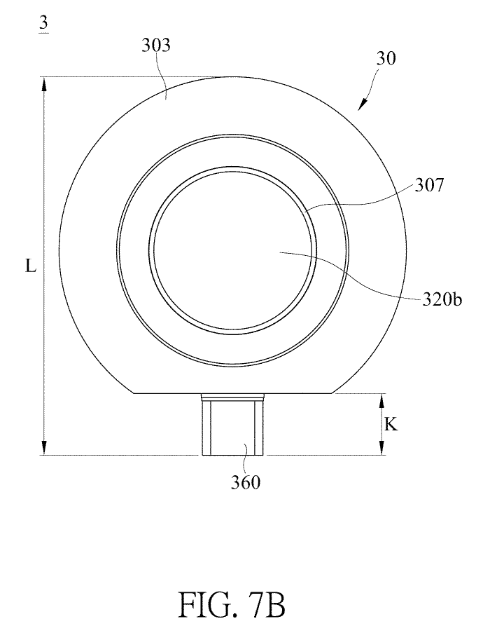

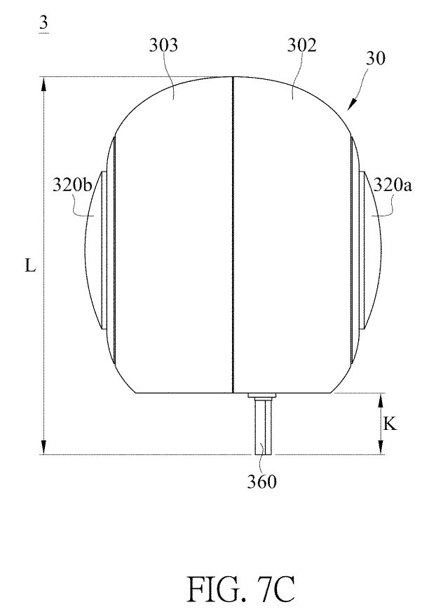

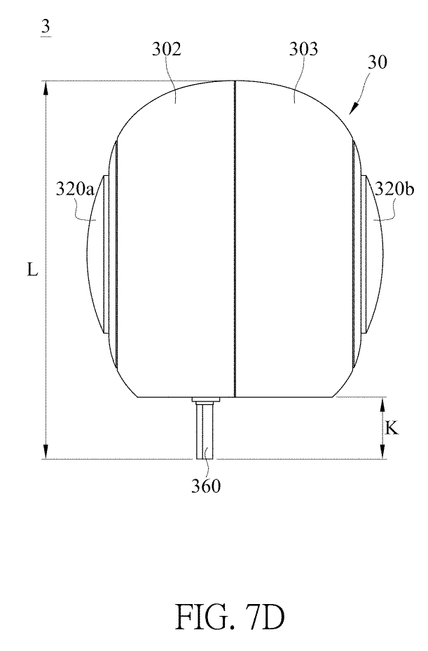

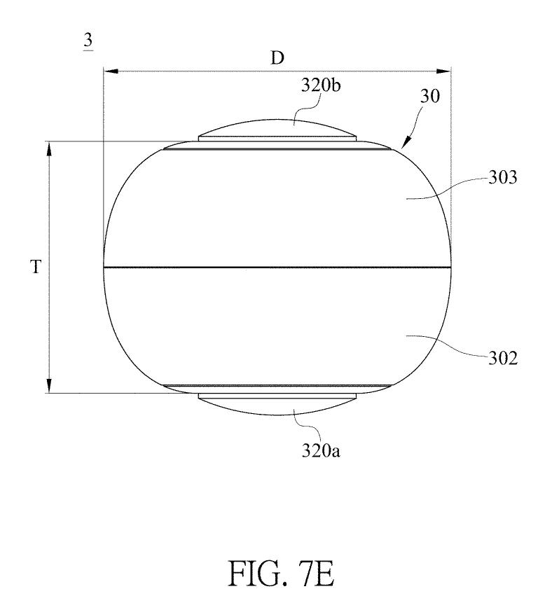

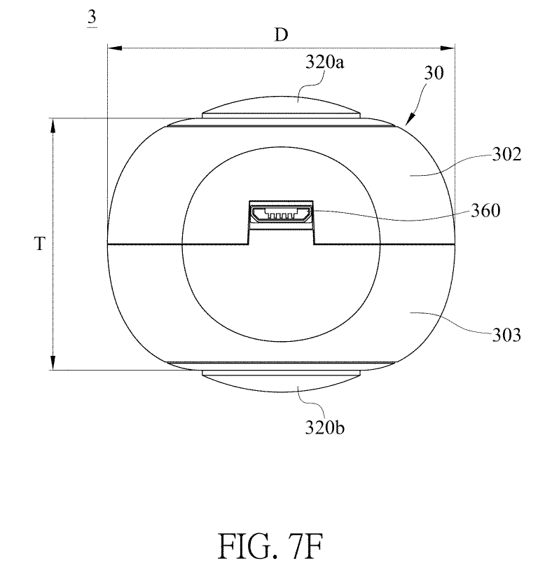

Further, please refer to FIG. 7A to FIG. 7F. FIG. 7A to FIG. 7F are diagrams illustrating a six-side view of the camera apparatus 3, and FIGS. 7A-7F utilize the size of the shell 30 of the camera apparatus 3 to illustrate a size shrink effect caused by the combination of the first printed circuit board 32 and the second printed circuit board 36, and any capturing audio data component not installed in the accommodation space 301 within the camera apparatus 3, but the present invention is not limited to FIGS. 7A-7F.

Please refer to a front view, a rear view, a left view, and a right view shown in FIGS. 7A-7D, respectively. After neglecting any component protruding from the inside of the shell 30 to the outside of the shell 30, a maximum length L of the shell 30 is equal or less than 5 cm, and the maximum length L can be reduced to 4 cm to 4.3 cm in a preferred embodiment, a length K of the connection port 360 protruding the shell 30 is equal or less than 0.7 cm. Further, please refer to a top view and a bottom view shown in FIGS. 7E-7F. After neglecting any component protruding from the inside of the shell 30 to the outside of the shell 30, a width D of the shell 30 can be between 3.5 cm to 4 cm (e.g. the width D of the shell 30 can be 3.6 cm). In addition, a thickness T of the shell 30 can be between 3 cm to 3.6 cm (e.g. the thickness T of the shell 30 can be 3.4 cm).

In other words, by not installing any sound capturing component in the accommodation space 301, the camera apparatus 3 can make the electronic apparatus 2 or other sound capturing apparatuses outside the camera apparatus 3 capture sound corresponding to the shooting area, so the present invention can further increase a number of lens groups, a number of winding machines for controlling the connection line, or other proper elements, or further shrink the size of the shell 30 to make the camera apparatus 3 be more convenient to carry. Therefore, use of the camera apparatus 3 can also be more diversified and convenient.

To sum up, the camera system and the camera apparatus can make the accommodation space of the camera apparatus be increased, or shrink the size of the shell of the camera apparatus by not installing any sound capturing component in the accommodation space of the camera apparatus and the configurations between the lens groups and the circuit boards. When the user chooses to capture environmental sound and images, image data captured by the camera apparatus can be combined with audio data captured by the sound capturing apparatus by time tags corresponding to the image data captured by the camera apparatus to form AV data. Thus, the present invention can utilize the accommodation space within the camera apparatus effectively, flexibly adjust the size of the camera apparatus, determine whether to mix the audio data captured by the sound capturing apparatus with the image data captured by the camera apparatus, and make overall use of the camera apparatus more flexible and convenient.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A camera apparatus, comprising:
a shell enclosing to form an accommodation space, wherein a maximum size of the shell corresponding to a non-predetermined axis is less than 5 cm; and
a first printed circuit board installed within the accommodation space, wherein a first lens group and a second lens group are installed on opposite sides of the first printed circuit board, respectively;
wherein the first lens group and the second lens group are used for capturing and outputting image data corresponding to a shooting area.

2. The camera apparatus of claim 1, wherein the image data comprise a plurality of image segments, each image segment of the plurality of image segments has a time tag, the image data are combined with audio data corresponding to the shooting area according to time tags of the plurality of image segments, and the audio data corresponding to the shooting area are generated from an external apparatus.

3. The camera apparatus of claim 1, further comprising:
a second printed circuit board installed within the accommodation space, wherein the first printed circuit board contacts with the second printed circuit board, and the first printed circuit board and the second printed circuit board are not located on a same plane.

4. The camera apparatus of claim 3, wherein the second printed circuit board is adjacent to a bottom of the accommodation space.

5. The camera apparatus of claim 3, wherein a connection port is installed on a bottom of the second printed circuit board, the connection port protrudes the shell, and the camera apparatus outputs the image data through the connection port.

6. The camera apparatus of claim 3, wherein the second printed circuit board has an engagement component, and one end of the first printed circuit board is engaged into the engagement component.

7. The camera apparatus of claim 6, wherein the first printed circuit board and the second printed circuit board are combined to form a combinational circuit board with “T” shape.

8. The camera apparatus of claim 6, wherein the end of the first printed circuit board further protrudes the engagement component.

9. The camera apparatus of claim 8, wherein the first printed circuit board and the second printed circuit board are combined to form a combinational circuit board with “+” shape.

10. The camera apparatus of claim 6, wherein the first printed circuit board contacts with the engagement component, and is coupled to the second printed circuit board through the engagement component.

11. The camera apparatus of claim 1, wherein the image data captured by the first lens group and the second lens group are time synchronization and color synchronization.

12. The camera apparatus of claim 1, wherein the maximum size of the shell corresponding to the non-predetermined axis is less than 3.6 cm.

13. A camera system, comprising:
a camera apparatus, comprising:
a shell enclosing to form an accommodation space, wherein a maximum size of the shell corresponding to a non-predetermined axis is less than a predetermined value; and
a first printed circuit board installed within the accommodation space, wherein a first lens group and a second lens group are installed on opposite sides of the first printed circuit board, respectively, the first lens group and the second lens group are used for capturing image data corresponding to a shooting area, the image data comprise a plurality of image segments, and each image segment of the plurality of image segments has a time tag; and
a sound capturing apparatus electrically connected to the camera apparatus, the sound capturing apparatus comprising:
a sound capturing circuit optionally capturing audio data corresponding to the shooting area when the first lens group and the second lens group capture the image data; and
a sound processor electrically connected to the sound capturing circuit, wherein when the sound processor receives the audio data captured by the sound capturing circuit, the sound processor combines the image data with the audio data according to time tags of the plurality of image segments.

14. The camera system of claim 13, wherein the audio data comprise a plurality of sound segments, a time length of each sound segment of the plurality of sound segments is equal to a time length of a corresponding image segment, the each sound segment has a synchronization tag corresponding to a time tag of the corresponding image segment, and the sound processor further combines the image data with the audio data according to the synchronization tag of the each sound segment.

15. The camera system of claim 13, wherein the camera apparatus further comprises a second printed circuit board, the second printed circuit board is installed within the accommodation space, the first printed circuit board contacts with the second printed circuit board, and the first printed circuit board and the second printed circuit board are not located on a same plane.

16. The camera system of claim 15, wherein the second printed circuit board is adjacent to a bottom of the accommodation space.

17. The camera system of claim 15, wherein a connection port is installed on a bottom of the second printed circuit board, the connection port protrudes the shell, and the connection port is used for being electrically connected to the sound capturing apparatus and outputting the image data to the sound capturing apparatus.

18. The camera system of claim 15, wherein the second printed circuit board has an engagement component, and one end of the first printed circuit board is engaged into the engagement component.

19. The camera system of claim 18, wherein the first printed circuit board and the second printed circuit board are combined to form a combinational circuit board with “T” shape.

20. The camera system of claim 18, wherein the end of the first printed circuit board further protrudes the engagement component.

21. The camera system of claim 20, wherein the first printed circuit board and the second printed circuit board are combined to form a combinational circuit board with “+” shape.

22. The camera system of claim 18, wherein the first printed circuit board contacts with the engagement component, and is coupled to the second printed circuit board through the engagement component.

23. The camera system of claim 13, wherein the image data captured by the first lens group and the second lens group are time synchronization and color synchronization.

24. The camera system of claim 13, wherein the maximum size of the shell corresponding to the non-predetermined axis is less than 5 cm.

25. The camera system of claim 13, wherein the maximum size of the shell corresponding to the non-predetermined axis is less than 3.6 cm.

26. A camera apparatus, comprising:
a shell enclosing to form an accommodation space, wherein a maximum size of the shell corresponding to a non-predetermined axis is less than a predetermined value; and
a first printed circuit board installed within the accommodation space, wherein a first lens group and a second lens group are installed on opposite sides of the first printed circuit board, respectively;
wherein the first lens group and the second lens group are used for capturing and outputting image data corresponding to a shooting area, the image data comprise a plurality of image segments, each image segment of the plurality of image segments has a time tag, the image data are combined with audio data corresponding to the shooting area according to time tags of the plurality of image segments, and the audio data are generated from an external apparatus.
